(19) United States
(12) Patent Application Publication
(10) Pub. No.: US 2008/0072405 A1
(43) Pub. Date: Mar. 27, 2008

(54) EA component and attachment structure of EA component

(75) Inventor: Toshiyuki Horimatsu, Yokohama-shi (JP)

Correspondence Address: SUGHRUE MION, PLLC, 2100 PENNSYLVANIA AVENUE, N.W., SUITE 800, WASHINGTON, DC, 20037, US

(73) Assignee: Bridgestone Corporation, Chuo-ku (JP)

(21) Appl. No.: 11/898,401

(22) Filed: Sep. 12, 2007

(30) Foreign Application Priority Data
Sep. 13, 2006 (JP) 2006-247940
Sep. 13, 2006 (JP) 2006-247941

(51) Int. Cl. F16B 21/06

(52) U.S. Cl. 24/704.1

(57) ABSTRACT

An EA component and an attachment structure thereof capable of absorbing a positional error between a projection or the like on a side of a component such as a trim or the like, and a clip of the EA component. An EA component 1 is the one in which a clip 4 is integrally formed with an EA component body 3 formed from hard urethane foam via an elastically deformable component 20. The elastically deformable component 20 is provided with a hole 21 where a tubular portion 6 of a clip 4 made of hard synthetic resin is inserted, shallow and round concave portions 22 respectively provided in both end surfaces, and a slot 23. When the EA component 1 is attached to a trim 2, even when a projection 8 and the tubular portion 6 of the clip 4 are deviated to some degree in position, the EA component 1 can be attached to the trim 2 while allowing the positions of the projection 8 and the tubular portion 6 to be in alignment with each other, because the clip 4 can be moved in a direction along a plate surface of the trim 2 in a manner so as to push and shorten the elastically deformable component 20.

### FIELD OF THE INVENTION

The present invention relates to an EA component (impact energy absorption component) and an attachment structure thereof, and more specifically to an EA component and an attachment structure thereof preferable to be applied to a trim of an automobile.

### BACKGROUND OF THE INVENTION

An EA component formed of hard urethane is attached to a door trim of an automobile for impact energy absorption (Energy Absorption: EA) in a side collision (side impact). As a method of attaching an EA component made of hard urethane to the door trim, a structure illustrated in FIG. 4a through 4c is described in Japanese Unexamined Patent Application Publication No. 2004-150629.

FIG. 4a is a cross-sectional view in an approximately horizontal direction illustrating an attachment structure of the EA component, FIG. 4b is a perspective view illustrating a latch portion of an attachment structure of an EA component, and FIG. 4c is a perspective view illustrating a to-be-latched portion of the attachment structure of the EA component.

An EA component 1′ formed of synthetic resin such as hard urethane foam or the like is attached to a trim (for example, a door trim) 2 serving as a component via a projection 8 and a clip 4. The clip 4 is provided in the EA component 1′, and a latch portion 3 is engaged with the clip 4.

A pair of the projections 8 is standing upright from the trim 2. On a side surface in a projecting direction of the projection 8, an overhanging portion 8a is provided in an overhung manner toward a side. The overhanging portion 8a has an overhanging height becoming increasingly large sideways toward a base end side of the projection 8. Thereby, the projections 8 and 8 can be easily inserted into an insertion hole 12 of the clip 4, described later.

The projection 8 is molded with synthetic resin having elasticity, and the projections 8 and 8 are deformable in an approaching direction.

The clip 4 is provided with a tubular portion 6, an anchor 5 formed from a flange portion overhanging from a rear end of the tubular portion 6 in an outward flange-like manner, an a flange 7 overhanging from a tip end of the tubular portion 6 in an outward flange-like manner. In the clip 4, the insertion hole 12 passing through the flange 7, the tubular portion 6, and the anchor 5 is provided in an axis line direction thereof, and a step portion 13 is installed in a depressed manner in a peripheral direction on an inner peripheral surface of the insertion hole 12.

As illustrated in FIG. 4a, the tubular portion 6 and the anchor 5 of the clip 4 are buried in the EA component 1′.

The EA component 1′ with the clip 4 is attached to the trim 2 by allowing the projections 8 and 8 to come in contact with the trim 2 while inserting the same into the insertion hole 12. When the EA component 1′ is pressed to the trim 2, the projections 8 and 8 are press fitted into the insertion hole 12. By means of that the overhanging portion 8a is pressed to the inner peripheral surface of the insertion hole 12, the projections 8 and 8 are inserted into the insertion hole 12 while sagging in the approaching direction. Further, when the overhanging portion 8a reaches the step portion 13, the projections 8 and 8 tend to elastically return to an original shape, and an edge portion of the step portion 13 is sandwiched by the overhanging portion 8a and the trim 2. Furthermore, the projections 8 and 8 are brought into contact with the inner peripheral surface of the insertion hole 12 of the clip 4.

Thus, the EA component 1′ can be attached to the trim 2 by only one process of operation of overlapping the EA component 1′ with the clip 4 with the trim 2, the attachment operation efficiency is significantly improved. Further, since the edge portion of the step 13 is sandwiched by the overhanging portions 8a and 8a of the projections 8 and 8 and the trim 2, and in addition, outer peripheral surfaces of approximately half-cylindrical column portions 8b and 8b are in contact with the inner peripheral surface of the insertion hole 12, the EA component 1′ is restrained in any of a surface direction or a contacting-separating direction of the trim 2.

In the aforementioned attachment structure of the EA component using the clip 4 and the projections 8 and 8, as illustrated in FIG. 4, when a positional deviation exists between the projection 8 and the clip 4, there is a possibility that the projection 8 is inserted into the insertion hole 12 in a slanting manner and thereby the latch becomes loose, or the projection 8 cannot be inserted into the insertion hole 12 in case the positional deviation is large and thereby the EA component cannot be attached. As a result, when the hole is formed to have a long diameter, a rattle sometimes tends to be generated.

Another conventional example (described in the related art section in Unexamined Japanese Patent Application Publication No. 2006-21614) of a structure where a hard urethane-made EA component is attached to the door trim is illustrated in FIG. 9. In this conventional example, an EA component 41A formed from hard urethane foam is attached to a trim 42. A tubular clip 43 is integrally provided in an ear-shaped convex portion 45 projecting from the EA component 41A. A column-shaped projection 44 projecting from the trim 42 is inserted into the clip 43, and a tip end of the projection 44 is diameter-expanded to form a flange-shaped pressing member 44a. Thus, the EA component 41A is fixed to the trim 42.

When an object such as a human body or the like hits the aforementioned EA component 41A, the EA component 41A is deformed and thereby the impact energy is absorbed.

In the aforementioned attachment structure of the EA component using the clip 43 and the projection 44, as illustrated in FIG. 9, when a positional deviation between the projection 44 and the clip 43 is large, the projection 44 cannot be inserted into the clip 43, and the EA component cannot sometimes be attached to the trim. If the hole is formed to have a long diameter so that the positional deviation is absorbed, an attaching force is not sufficient and the rattle tends to be generated.

### SUMMARY OF THE INVENTION

It is an object of the present invention to provide an EA component capable of absorbing a positional error between a projection or the like of a side of a component such as a trim and a clip of the EA component, and an attachment structure thereof.

[First Aspect]

An EA component of a first aspect is characterized in that in an EA component having a facing surface so as to face a component including an EA component body formed from synthetic resin foam, and a clip for use in attaching the EA component being disposed in the facing surface, and integrally formed with the EA component, the clip is configured to be variable in position in a surface direction of the facing surface relative to the EA component body.

EA component is attached to a component such as a trim or the like via the clip.

In an embodiment of the first aspect, an elastically deformable component is disposed between the clip and the EA component body, and thereby the clip is configured to be variable in position relative to the EA component body.

It is preferable that in this case, the clip is provided with a tubular portion where a projection for attaching the EA component is inserted inside thereof, and flanges respectively provided on both end sides in a direction of a cylinder axis center of the tubular portion, and the elastically deformable component is surrounding outer peripheries of the tubular portion and the flanges.

It is preferable that the elastically deformable component is a soft foam component.

In another embodiment of the first aspect, a clip holder is disposed between the clip and the EA component body, and the clip is slidably held relative to the clip holder, and thereby the clip is configured to be variable in position relative to the EA component body.

It is preferable that in this case the clip is provided with a tubular portion where a projection for use in attaching the EA component is inserted inside thereof and flanges overhanging from the tubular portion, and the clip holder is provided with a holding portion slidably holding the flanges.

Further, it is preferable that the flanges are respectively provided on both end sides in a direction of a cylinder axis center of the tubular portion, and the holding portion of the clip holder is intruded between each of the flanges and is slidably sandwiched by means of the flanges.

In the first aspect, since the clip is variable in position in a surface direction of the facing surface relative to the EA component body, even when there is a positional deviation between the projection of the component or the like and the clip of the EA component, it is possible to attaché the EA component while allowing the positions of the projection or the like and the clip to be in alignment with each other by varying a position of the clip.

In order to configure the clip to be variable in position relative to the EA component body, when an elastically deformable component such as soft foam component or the like is disposed between the clip and the EA component body, the EA component can be constructed at low cost.

Furthermore, in order to configure the clip to be variable in position relative to the EA component body, when a clip holder is disposed between the clip and the EA component body, and a flange portion of the clip is slidably held by a holding portion of the clip holder, a position area of the clip can be enlarged.

Specifically, when the flange portion is provided on both ends of the clip, and the holding portion is intruded between each of the flange portions and slidably sandwiched by the flange portions, since both end sides of the clip are constructed to be slid and guided, the clip can be smoothly moved.

[Second Aspect]

An EA component of a second aspect is characterized in that in an EA component having a facing surface so as to face a component, including an insertion hole where a projection for use in attaching the EA component provided on the component is inserted, the inner peripheral surface of the insertion hole is constructed with a soft component so that the projection is brought to be variable in position in a surface direction of a facing surface.

The EA component is attached to a component such as a trim or the like, by means of that the projection projected from the component is inserted into the insertion hole.

In the second aspect, since an inner peripheral surface of a projection insertion hole of the EA component is constructed with a soft component, even when there is a positional deviation between the projection of the component or the like, and the projection insertion hole of the EA component, the projection can be inserted into the insertion hole by deforming the soft component, and thereby the EA component can be attached.

By means of forming the soft component to be a cylindrical shape, the EA component is sufficiently applicable for the positional deviations in all directions.

As a soft component, the soft foam component is inexpensive and is preferable. The soft component is preferable to be disposed in, for example, a metal mold for use in forming an EA component, and integrally formed when a foam-molding operation is performed for the EA component.

### BRIEF DESCRIPTION OF THE DRAWINGS

FIGS. 1a and 1b are perspective views illustrating a clip and an elastically deformable component according to an embodiment.

FIG. 2 is a cross-sectional view illustrating an EA component attachment structure according to the embodiment.

FIGS. 3a and 3b are explanatory views of another embodiment.

FIGS. 4a through 4c are explanatory views of a conventional example.

FIG. 5 is a cross-sectional view illustrating an EA component attachment structure according to an embodiment.

FIGS. 6a and 6b are a perspective view and a cross-sectional view illustrating an EA component attachment structure according to an embodiment.

FIGS. 7a and 7b are a perspective view and a cross-sectional view illustrating an EA component attachment structure according to an embodiment.

FIG. 8a through 8c are a cross-sectional view and perspective views illustrating an embodiment.

FIG. 9 is an explanatory view illustrating a conventional example.

FIG. 10a is a perspective view illustrating a soft component used in another embodiment. FIG. 10b is a perspective view illustrating a part of an EA component using a soft component of FIG. 10a.

FIG. 11 is a perspective view illustrating a soft component used in another embodiment.

### DETAILED EXPLANATION

Hereinbelow, preferred embodiments will be explained with reference to the drawings.

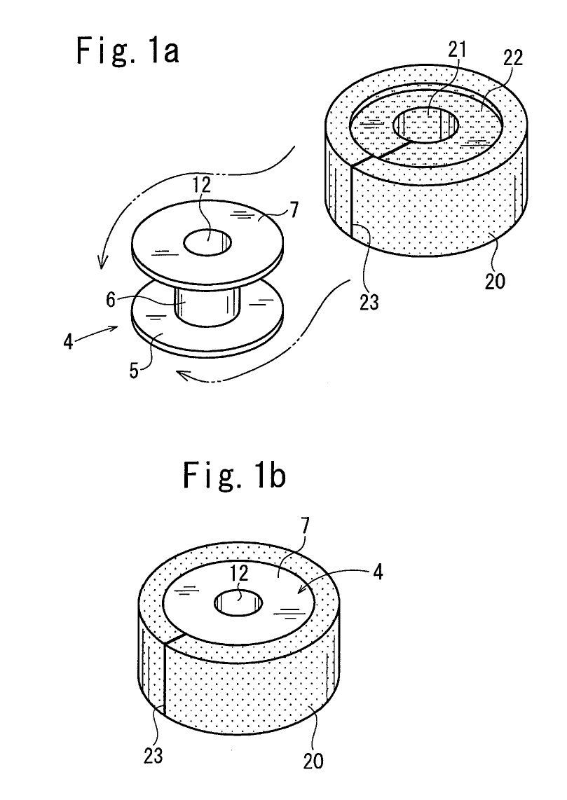

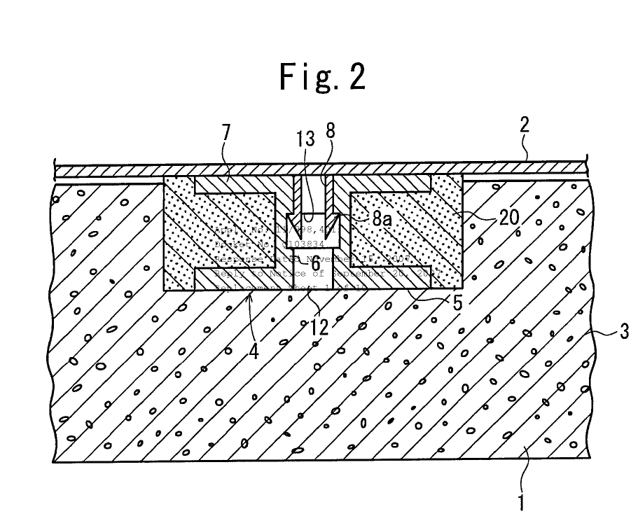

FIG. 1a is a perspective view illustrating a clip and an elastically deformable component according to an embodiment, FIG. 1b is a perspective view illustrating a condition where an elastically deformable component 20 is fitted upon the clip, and FIG. 2 is a cross-sectional view illustrating an EA component attachment structure provided with the clip with the elastically deformable component 20.

In this embodiment, an EA component 1 is the one in which a clip 4 is integrally formed with an EA component body 3 formed from hard urethane foam via the elastically deformable component 20.

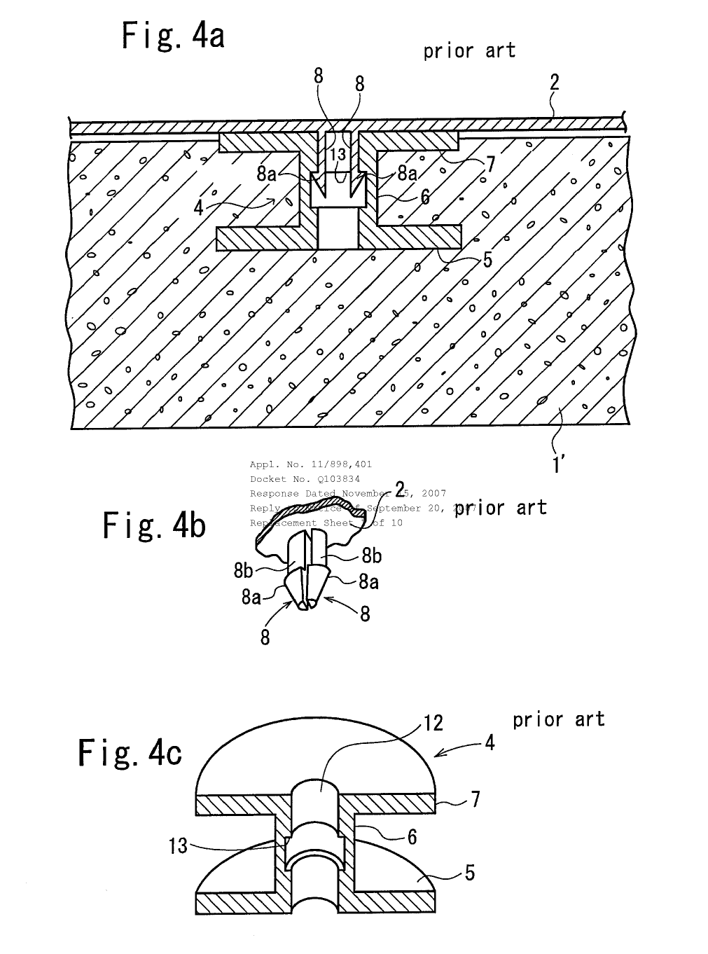

The clip 4 used in this embodiment is the same one illustrated in the aforementioned FIGS. 4a through 4c, and the same numerical references denote the same elements.

The elastically deformable component 20 is a thick-walled tubular component formed from soft foam such as soft urethane foam or the like. This elastically deformable component 20 is provided with a hole 21 where the tubular portion 6 of the hard synthetic resin made clip 4 is inserted, shallow round concave portions 22 which are respectively provided at both end surfaces, and a slot 23. The concave portions 22 have the same depth as a thickness of the flange 7 and the anchor 5 of the clip 4. Incidentally, the flange 7 and the anchor 5 are flange-shaped flange portion having completely the same shape and the same dimension, and even when inverted, the anchor is configured to be buried in the EA component.

The hole 21 passes through a center portion of the elastically deformable component 20 and the round concave portions 22 are concentrically formed with the hole 21.

An inner diameter of the hole 21 is configured to be the same as an outer diameter of the tubular portion 6. The slot 23 is extended in a radial direction in a manner so as to connect an outer peripheral surface and an inner peripheral surface of the elastically deformable component 20.

While pushing open the slot 23 and out-fitting the elastically deformable component 20 to the clip 4, an assembled condition illustrated in FIG. 1b is constructed.

By means of performing a foam-molding operation for the EA component while setting the clip 4 with which the elastically deformable component 20 is assembled in a metal mold for use in molding an EA component, an EA component 1 in which the clip 4 is integrally formed with the EA component body 3 is obtained as illustrated in FIG. 2. The elastically deformable component 20 formed from a soft foam component is allowed to intervene between an outer periphery of the clip 4 and hard urethane foam constructing the EA component body 3.

Hence, when the EA component 1 is attached to the trim 2, even when the projection 8 and the tubular portion 6 of the clip 4 have deviations to some degree in position, the clip 4 can be moved in a direction along a facing surface toward the trim 2 (upper surface of the EA component body 3 in FIG. 2) in a manner such that the elastically deformable component 20 is pushed and shortened. As a result, the EA component 1 can be attached to the trim 2 while aligning the positions of each of the projection 8 and the tubular portion 6.

Incidentally, when the elastically deformable component 20 is made of soft urethane foam, it is preferable that the diameter of the elastically deformable component 20 is in an extent of about 1.1 to 3.0 times that of the anchor 5 and the flange 7.

However, the elastically deformable component 20 may be made of soft rubber.

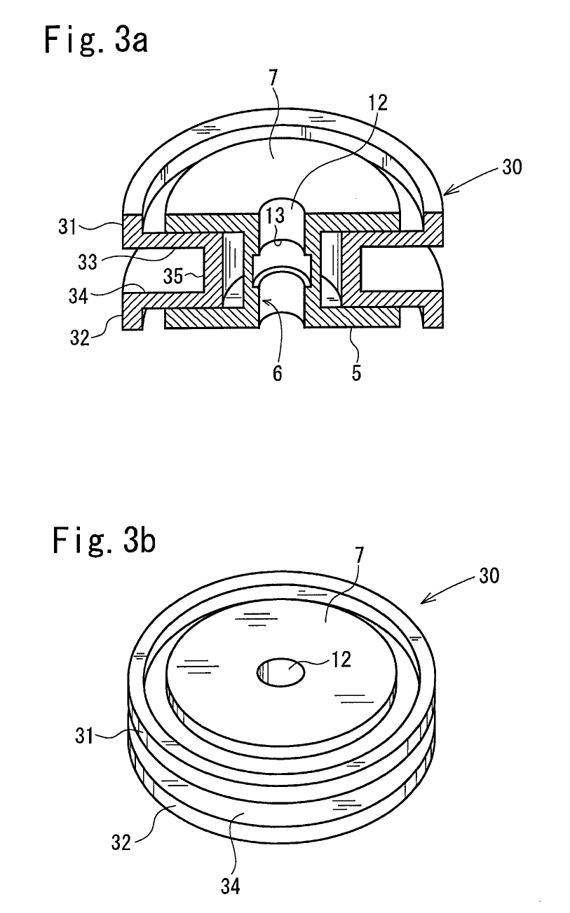

FIGS. 3a and 3b are a cross-sectional perspective view and a perspective view illustrating an assembled condition of a clip and a clip holder used for an EA component according to another embodiment.

In this embodiment, the clip 4 is held by a circular clip holder 30 made of hard synthetic resin. The clip holder 30 is provided with a first circular portion 31 disposed around the flange 7 of the clip 4, a second circular portion 32 disposed around an outer periphery of the anchor 5, a first circular plate portion 33 extending from the first circular portion 31 in a direction of a center of a circle along a plate surface of the flange 7 (a surface facing the anchor 5), a second circular plate portion 34 extending from the second circular portion 32 in a direction of a center of a circle along a plate surface of the anchor 5 (a surface facing the flange 7), and a tubular portion 35 connecting each of inner peripheral edges of the first circular plate portion 33 and the second circular plate portion 34. Each of the circular plate portions 33 and 34 has a disk shape where a hole is opened in the center thereof, and the tubular portion 35 is continued to an inner peripheral edge thereof as described above. A holding portion is constructed with the circular plate portions 33 and 34, and the tubular portion 35. The holding portion is intruded between the flange 7 and the anchor. The first circular plate portion 33 is slidably overlapped with the flange 7 and the second circular plate portion 34 is slidably overlapped with the anchor 5.

An inner diameter of the tubular portion 35 is greater than an outer diameter of the tubular 6 of the clip 4, and a predetermined clearance is opened between the tubular portion 6 and the tubular portion 35.

Hence, when the clip 4 with the clip holder 30 is integrally formed with the EA component 1 in a similar manner as in the aforementioned FIG. 2, even when the tubular portion 6 of the clip 4 is deviated from the projection 8 in position, the clip 4 slides along the trim 2 and the tubular 6 is allowed to be in alignment with the projection 8 and the projection 8 can be inserted into the tubular portion 6.

In this embodiment, since the anchor 5 and the flange 7 respectively slide along the circular plate portions 33 and 34, the clip 4 smoothly moves along the trim 2.

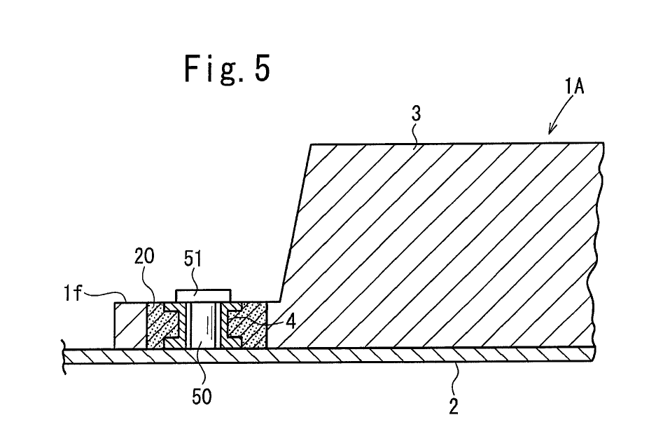

FIG. 5 is a cross-sectional view illustrating an EA component attachment structure according to a still another embodiment. In this embodiment, a plurality of numbers of ear-shaped projecting piece portions if is provided at an outer edge portion of a disk-shaped EA component 1A. The clip 4 is provided in the projecting piece portion 1f via the elastically deformable component 20. An attachment pin 50 projected from the trim 2 passes through a hole of the clip 4. A flange-shaped hold-down portion 51 is provided by performing a diameter-expanding process for a tip end of the pin 50, and thereby the EA component 1A is attached to the trim 2. In this embodiment, the same advantage as that in the aforementioned embodiment can be achieved.

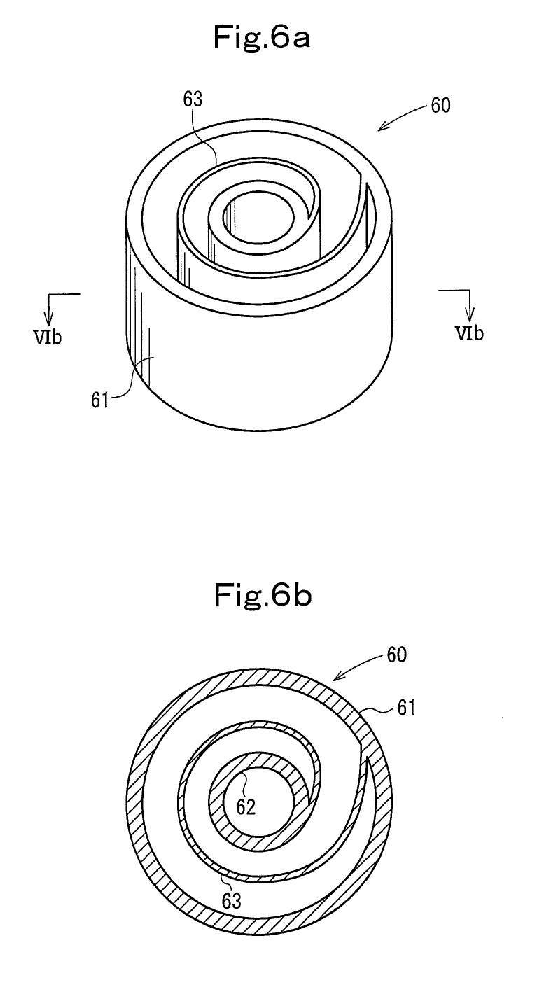

FIG. 6a is a perspective view illustrating a clip 60 used for an EA component according to still a further embodiment, and FIG. 6b is a cross-sectional view taken along a VIb-VIb line in FIG. 6a.

This clip 60 is provided with an outer circle 61 and an inner circle 62 disposed inside the outer circle 61. The outer circle 61 and the inner circle 62 are coupled by a spiral spring 63.

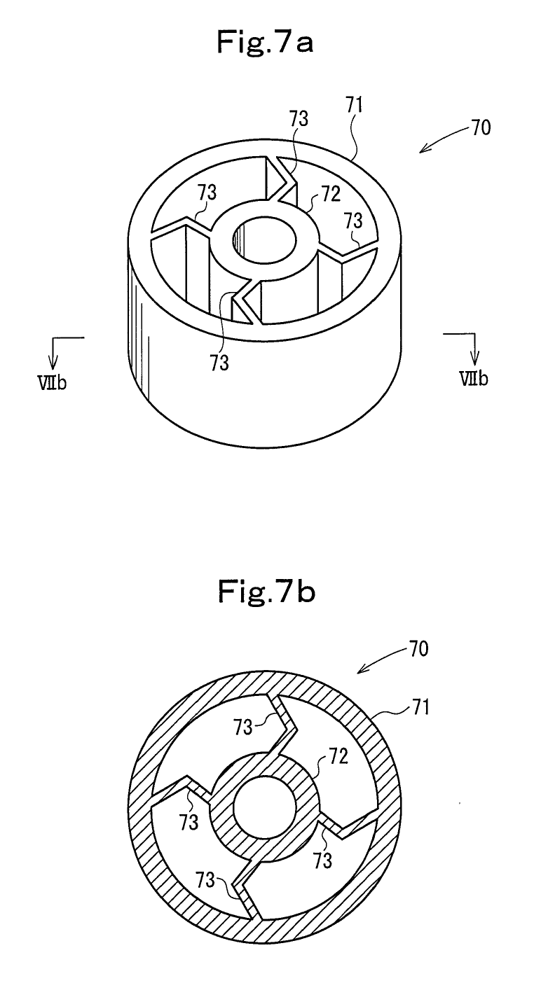

FIG. 7a is a perspective view illustrating a clip 70 used for an EA component according to still another embodiment, and FIG. 7b is a cross-sectional view taken along a VIIb-VIIb line in FIG. 7b.

This clip 70 is provided with an outer circle 71 and an inner circle 72 disposed inside the outer circle 71. The outer circle 71 and the inner circle 72 are coupled by a plurality of sheets of springs 73 having a cross-sectional shape of an approximately L-shape. Incidentally, although the spring 73 has a cross-sectional shape of the approximately L-shape, the same may have a cross-sectional shape in zigzag such as a W shape or the like, and S-shaped cross-sectional shape may be applicable.

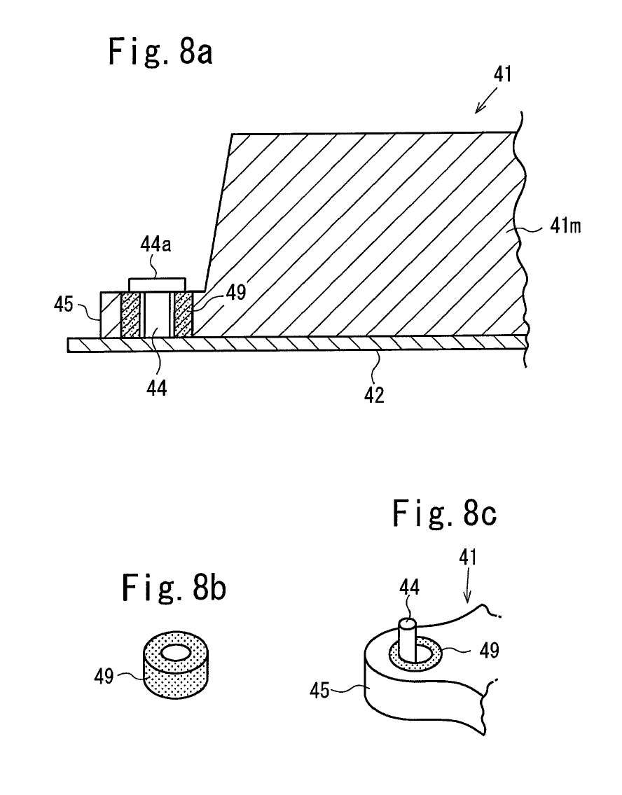

FIG. 8a is a cross-sectional view illustrating an attachment structure of an EA component according to another embodiment. FIG. 8b is a perspective view illustrating a soft component, and FIG. 8c is a perspective view illustrating an inserted condition of a projection of the EA component.

In this embodiment, the EA component 41 is the one in which a cylindrically shaped soft component 49 is provided in an ear-shaped convex portion 45 of an EA component body 41m formed from hard urethane foam.

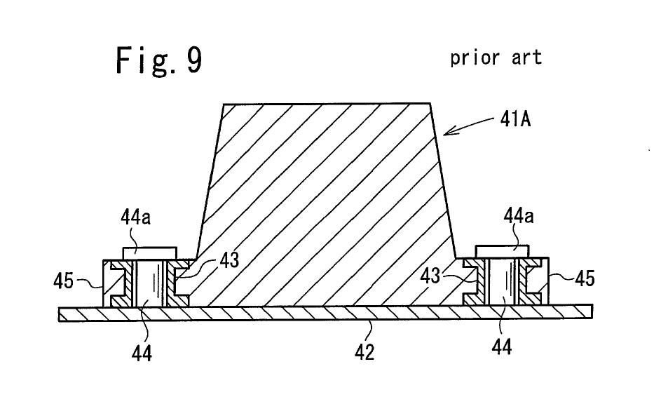

An outer shape of the EA component body 41m used in this embodiment is the same as that of the EA component 41A illustrated in the aforementioned FIG. 9, and the same numerical references denote the same elements.

The soft component 49 is a thick-walled tubular component formed from soft foam such as soft urethane foam or the like.

By means of performing a foam-molding operation for the EA component body 41m while setting the soft component 49 in a metal mold for use in molding an EA component, an EA component 41 in which the soft component 49 is integrally formed with the EA component body 41m is obtained as illustrated in FIGS. 8a and 8c. An inner hole of the cylindrically shaped soft component 49 becomes an insertion hole of the projection 44. Hence, the soft component 49 formed from a soft foam component is allowed to intervene between an outer periphery of the projection 44 inserted into the insertion hole and hard urethane foam constructing the EA component body 41m.

Accordingly, when the EA component 41 is attached to the trim 42, even when the projection 44 and the insertion hole have deviations to some degree in position, the position of the projection 44 is allowed to be in alignment with that of the insertion hole, and the EA component 41 can thus be attached to the trim 42. This is because the soft component 49 can be pushed and shortened in a direction along a surface which faces the trim 42 (a lower surface of the EA component body 41m in FIG. 8a).

Incidentally, although it is preferable that the soft component 49 is made of soft urethane foam, the same may be made of soft rubber.

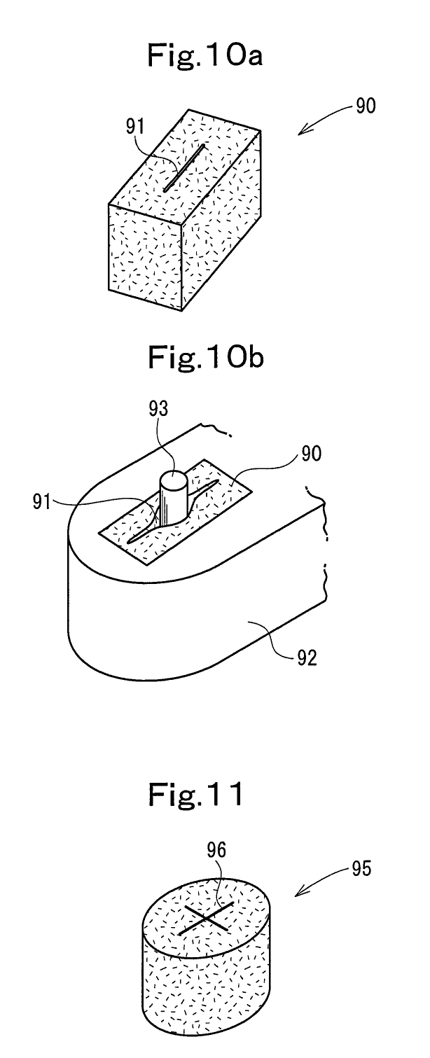

Although the soft component 49 illustrated in FIGS. 8a and 8c has a cylindrical shape, alternatively, a soft component 90 having a slit 91 passing through a thickness direction may be used as illustrated in FIG. 10a. A projection 93 of a trim is inserted into the slit 91 as illustrated in FIG. 10b. Thereafter, a tip end of the projection 93 is deformed into a flange shape. The projection 93 can be easily moved in a width direction of the slit 91.

Although the slit 91 of the soft component 90 in FIGS. 10a and 10b is formed of a “−” shape, a soft component 95 having a slit 96 formed of a “+” shape as illustrated in FIG. 11 can be used. A projection inserted into the slit 96 can be easily moved in two directions.

Any of the aforementioned embodiments is an example of the present invention and the present invention may have configurations other than illustrated.

Although the present invention has been described in detail in conjunction with the specified embodiments thereof, it is apparent to those skilled in the art that various modifications may be made without departing from the spirit and scope of the invention.

Incidentally, the present application is based on Japanese Patent Application (Japanese Patent Application Nos. 2006-247940 and 2006-247941), respectively filed on Sep. 13, 2006 and the entire contents of which is hereby incorporated by reference.

1. An EA component having a facing surface so as to face a component comprising:
an EA component body formed from synthetic resin foam; and
a clip for use in attaching the EA component being disposed in the facing surface, and integrally formed with the EA component,
wherein the clip is configured to be variable in position in a surface direction of the facing surface relative to the EA component body.

2. The EA component according to claim 1, wherein an elastically deformable component is disposed between the clip and the EA component body, and thereby the clip is configured to be variable in position relative to the EA component body.

3. The EA component according to claim 2, wherein the clip is provided with a tubular portion where a projection for attaching the EA component is inserted inside thereof, and flanges respectively provided on both end sides in a direction of a cylinder axis center of the tubular portion, and wherein the elastically deformable component is surrounding outer peripheries of the tubular portion and the flanges.

4. The EA component according to claim 2, wherein the elastically deformable component is a soft foam component.

5. The EA component according to claim 1, wherein a clip holder is disposed between the clip and the EA component body, and the clip is slidably held relative to the clip holder, and thereby the clip is configured to be variable in position relative to the EA component body.

6. The EA component according to claim 5, wherein the clip is provided with a tubular portion where a projection for use in attaching the EA component is inserted inside thereof and flanges overhanging from the tubular portion, and wherein the clip holder is provided with a holding portion slidably holding the flanges.

7. The EA component according to claim 6, wherein the flanges are respectively provided on both end sides in a direction of a cylinder axis center of the tubular portion, and the holding portion of the clip holder is intruded between each of the flanges and is slidably sandwiched by means of the flanges.

8. An attachment structure of the EA component, wherein the EA component according to claim 1 is attached to the component via the clip of the EA component.

9. The attachment structure of the EA component according to claim 8, wherein the component is a trim of an automobile.

10. An EA component having a facing surface so as to face a component, comprising an insertion hole where a projection for use in attaching the EA component provided on the component is inserted, wherein the inner peripheral surface of the insertion hole is constructed with a soft component so that the projection is brought to be variable in position in a surface direction of a facing surface.

11. The EA component according to claim 10, wherein the soft component has a cylindrical shape.

12. The EA component according to claim 10, wherein the soft component is a soft foam component.

13. The EA component according to claim 10, wherein the EA component is constructed with an EA component body formed from hard urethane foam, and the soft component.

14. An attaching structure of an EA component, wherein the EA component according to claim 10 is attached to the component by means of that a projection projected from the component is inserted into the insertion hole.

15. The attaching structure of an EA component according to claim 14, wherein the component is a trim of an automobile.
